(19) United States
(12) Patent Application Publication
(10) Pub. No.: US 2015/0331851 A1
(43) Pub. Date: Nov. 19, 2015

(54) Assisted input of rules into a knowledge base

(71) Applicant: COMMISSARIAT A L'ENERGIE ATOMIQUE ET AUX ENERGIES ALTERNATIVES, Paris (FR)

(72) Inventors: Jean-Philippe POLI, Paris (FR); Jean-Paul LAURENT, Villepreux (FR)

(21) Appl. No.: 14/618,350

(22) Filed: Feb. 10, 2015

(30) Foreign Application Priority Data
Feb. 10, 2014 (FR) 1450996

(51) Int. Cl. G06F 17/27; G06F 17/28; G06N 5/02

(52) U.S. Cl. CPC G06F 17/2785; G06N 5/02; G06F 17/28; G06F 17/2775

(57) ABSTRACT

There is disclosed a method implemented by computer for manipulating a sentence expressed in natural language comprising the determination of one or more destination locations in an initial sentence in response to the selecting of one or more words, said destination locations or “ghost locations” being determined by syntactic analysis of the sentence. Various developments include the display of the destination location or locations in response to the selecting of the word or words, and the display of one or more suggestions of words corresponding to the one or more ghost locations. Semantic validations by logical verification, by similarity and by graph analysis are described. System aspects are described, including the employment of a touch-sensitive tablet.

### FIELD OF THE INVENTION

The invention relates to the field of man-machine interfaces and in particular the optimization of the ergonomics of a man-machine interaction for a knowledge-based system.

### PRIOR ART

In knowledge based systems, it is often necessary to formalize and to input at the keyboard the human expertise which will subsequently be utilized by decision aid algorithms. This step of inputting knowledge, which can take for example the form of “rules” in the case of an expert system or a fuzzy expert system, is often tiresome with existing procedures. These procedures are often rather unintuitive and/or are addressed at a scientific or educated public.

The procedures described in the patent literature (such as U.S. Pat. No. 4,891,766, U.S. Pat. No. 8,140,991, U.S. Pat. No. 8,364,469 or U.S. Pat. No. 7,949,738) comprise limitations.

Generally, there exist various procedures for inputting knowledge, the main ones being free text input, “auto completed” text input, the “graphical programming” approach and the “decision matrix” approach. These procedures comprise limitations, of diverse nature. For example free text input requires the input of a large amount of text, a great part of which ultimately turns out to be irrelevant. Few procedures are suitable for inputting on touch-sensitive interface. Certain algorithms may be very dependent on the grammar and spelling used by the user. Certain procedures are unsuitable for changes of language. Most require a high level of abstraction, not facilitating access to input by people without mathematical or computer training.

The invention proposed in the present document makes it possible to address these needs or limitations, at least in part.

### SUMMARY OF THE INVENTION

There is generally disclosed a method for inputting expert knowledge, in the form of sentences or rules, expressed in natural language form, by means of a specific graphical interface and of a protocol for assisting the writing of the rules relying on natural language analysis techniques. Display procedures and automatic language processing procedures are therefore tightly intertwined.

According to a particular embodiment, methods and systems are proposed for the editing or more generally the manipulating of rules. The user manipulates “elements”. For example, these elements of rules may be words, verbs, noun phrases, fragments of sentences, parts of sentences, etc. These elements are proposed by a graphical interface as a function of their appropriateness to what has already been written. The user can drag a new element over a certain number of possible locations that are shown to him by a so-called feedforward mechanism. These locations guarantee the syntactic correctness of the sentence. An element comprises fixed words and words to be completed with a list of choices or a menu, which automatically adapt their content to suit the choices already made by the user. When the user moves over an area in which he can drop the element that he is dragging, he may optionally receive visual feedback (this could also be a vibration within the framework of a haptic interface for example).

There is disclosed a method implemented by computer for manipulating a sentence expressed in natural language comprising the determination of one or more destination locations in an initial sentence in response to the selecting of one or more words, said destination locations being determined by syntactic analysis of the sentence.

Generally, there is disclosed an “integrated” procedure for natural language text input, for which the various inputs are (necessarily) syntactically exact. The destination locations are also called “ghost locations” or “ghosts” in the description. The words can be input by the user, or pre-existing in a static manner, or else extracted dynamically from a database (for example as a function of the sentence). The mechanism is of feedforward type. The selection and the syntactic analysis of the sentence are linked, but all the temporal possibilities of order (e.g. scheduling) are open (selection triggering the syntactic calculation, or precalculation of the locations and selection corresponding to a confirmation, etc). The expression “in response to the selecting” underlines the fact that as soon as a word is selected, the syntactic analyser can undertake the analysis and thereby ascertain (or indeed propose, i.e. display) the destination locations. It should be noted that these syntactic analyses can also be performed pro-actively, that is to say in anticipation. The selecting of a word is then a confirmation of a pre-performed calculation.

It is underlined that a destination location may correspond to one or more words, which word or words would be apt (syntactically) at this location or another location. For example, in English grammar, a direct object may give rise to a single word (for example “light”, of the noun type) or to several words (for example “white light”, of noun and adjective type). A destination location can therefore be complex.

In a development, the method comprises the display of the destination location or locations in response to the selecting of the word or words. In a development, the destination locations are actually displayed (for example on a touch screen). In other embodiments, the determination of the destination locations can be processed by different software bricks and these locations are therefore not necessarily displayed. When an element selected and positioned by the user can take several visual forms, it may appear under one visually different from the remainder (for example greyed). Selection, in the case where the user has been provided with visual feedback, may for example correspond to a drag-and-drop operation according to which an object can be virtually selected, moved and dropped at a certain site of the user interface. In a first embodiment, the “drag-and-drop” can be effective, that is to say correspond to a completed or terminated operation, i.e. that the user has dropped (“released”) the previously selected elements. At that time, the system can determine the ghost locations (nature and site). In a second embodiment, the “drag-and-drop” can be ongoing, that is to say as soon as the selection operation is performed by the user, the system determines the nature and the site of the ghost locations.

In a development, the method comprises the display of one or more suggestions of words corresponding to the one or more ghost locations. The “ghost” can react to a stimulus of the user (for example a click) so as to propose to him the various possible forms such that the syntactic validation remains valid. These possible forms or suggestions are drawn from a database for example.

In a development, the method comprises a semantic validation of the sentence formed by the insertion of the word or words selected in the initial sentence. In a development, the semantic validation is performed by logical verification. In a development, the semantic validation is performed by similarity comparison with rules known to be semantically valid. In a development, the semantic validation is performed by graph analysis.

The semantic verification is a step which can be performed in various ways. During the semantic verification, the consistency of the rule is verified, with respect to itself and also with respect to the other rules (for example present in the knowledge base, which may be static and/or predefined and/or closed (e.g. stable), or else dynamic (e.g. open); for example, the knowledge base may also result from searching over the network of already verified or validated rules). To verify the consistency of a given rule, it is possible, in an embodiment, to use algorithms which verify that its condition is not always true or always false. For example, contradictory logical relations (“A and B AND A and not B”) or duplicated logical relations (“A and B AND A and B”), inter alia, will lead to the rejection of the rule. To verify the consistency of a set of rules, in an embodiment, it is in particular possible to examine whether the inputs and the outputs of the system are all “covered” (that is to say for example to verify that the words input are known to the controlled vocabulary, i.e. finite and known or predefined). It is also possible, in another embodiment, as a supplement or independently to study the inter-similarity of two rules (and/or of the inputs and/or outputs of the rules considered). Accordingly, it is possible to make a syntactic comparison (that is to say by comparing the words of the two rules, to within their order) or more thorough comparison according to the logic used. For example, in the case of a mode of implementation according to a fuzzy logic approach, it is possible to look at the coverage of the sets for defining the input linguistic variables, but also (and notably) the topology as well as the geometry of the membership functions used within these linguistic variables. It is also possible to verify the consistency of a group of rules on the basis of their representation in graph form, in which a search is conducted for possible cycles (“cycles” or “circuits”, i.e. if two rules do not contradict one another).

In a development, the method furthermore comprises the addition of the semantically valid sentence to the knowledge base. In a development, said addition comprises a transformation of the representation associated with the semantically valid sentence into a representation of rule compatible with the knowledge base.

In a development, the method comprises the display of the sentence formed by the insertion of one or more words in response to the selecting of one or more destination location.

There is disclosed a system for the implementation of the method according to any one of the steps of the method. In particular, the system can comprise an entry keyboard and/or a touch-sensitive interface. The tangible aspects of the system comprise various other possibilities, for example physical keyboard, mouse and/or virtual keyboard on touch screen. The system can also comprise haptic feedback and/or sound emission and/or display means. For example, the choice of the destination locations can be guided or facilitated by the employment of sensory feedbacks (touch, sound and sight).

There is disclosed a computer program product, the said computer program comprising code instructions making it possible to perform any one of the steps of the method, when the said program is executed on a computer.

An embodiment of the invention combines the technical characteristics of inputting a sentence or rule expressed in natural language (a) with an integrated syntactic verification (b) and a subsequent optional semantic validation (d), without any need for models of predefined sentences or rules (d).

According to one aspect of the invention, there is used a mode of entry in natural language. Whereas the inputting of business rules is frequently limited to inputting rules in abstract forms, developments of the invention advantageously allow more natural inputting, in natural language form. Natural language (or “ordinary language”) corresponds to the “normal” language spoken by a human being, as opposed to so-called formal languages (for example computer, machine or programming language). The disclosed procedure makes it possible to easily read the knowledge input and thus to correct it, if necessary. As the rule or knowledge appears in natural language textual form, users find their errors more easily.

According to one mode of implementation, the procedure makes it possible to guide the user so that he does not produce any syntactic or semantic mistakes. For example, the insertion of logical operators can be done in a guided manner at precise locations in a sentence.

The embodiments of the invention do not require, in particular, any models of predefined rules or “prefabricated” sentences. Stated otherwise, there is no need to have to choose a model from among certain predefined models (as is required by certain known procedures). More precisely, it is possible to draft an entirely new rule. This drafting can be done, for example, by dragging various parts of rules and by arranging them mutually according to restrictions in the movements of these parts of rules so as to culminate in syntactically exact rules.

Experiments have made it possible to establish that the disclosed procedure makes it possible overall to rapidly draft syntactically correct rules. These tests have shown that overall the users write the rules more quickly, including those users who were not accustomed to drag-and-drop. The number of clicks has also been measured as being more limited than with the aid of the currently available interfaces. The user's cognitive burden is optimized. The man-machine interface is more effective. The definition of a framework for inputting knowledge (i.e. a vocabulary inherent to the type of knowledge to be entered) facilitates multilingual applications: only the vocabulary inscribed within the framework need be translated.

The combination of technical characteristics, in automatic processing of natural languages, and of user interface characteristics culminates in the obtaining of an advantageously flexible and rich procedure for inputting rules. This flexibility involves more than a simple effect on the form (i.e. than simple ergonomics as regards user interface): it allows the inputting (therefore the capture) of a very much greater richness of rules on the background. Accordingly, the expressivity of the captured rules is substantially greater with the present procedure, as compared with by means of other known techniques.

Generally, the examples provided facilitate man-machine interactions and in particular unburden the user of tiresome, sometimes repetitive and often complex manipulations, at the same time improving his capacity to concentrate in respect of actual input. Overall, the various embodiments lead to the optimization of the cognitive effort to be provided by the user during input. More exactly, this effort is reallocated to cognitive tasks that are more useful in regard to the objective considered. Stated otherwise, the technical effects related to certain aspects of the invention correspond to a reduction in the cognitive burden of the user of the man-machine interface. Genuine interactive dialogue between machine and man can then proceed, for example to maintain a high attention level, or best utilize the latter.

Advantageously, the invention can apply to the inputting and the editing of rules in a “fuzzy logic” expert system, that is to say a software module which makes it possible to control apparatuses or to aid decision and which relies on the principles of fuzzy logic. Such a system is an example of a knowledge based system. The knowledge in such a system is represented by rules of the form: “if a quantity is adjective and another quantity is adjective then the quantity of the output is adjective”. For example: “if the outside temperature is very cold and the rain is fine then the risk of black ice is large”.

### DESCRIPTION OF THE FIGURES

Various aspects and advantages of the invention will be apparent in support of the description of a preferred but non limiting mode of implementation of the invention, with reference to the figures herein below:

FIG. 1 presents a general view and certain aspects of the invention;

FIG. 2 illustrates an exemplary user interface;

FIGS. 3A, 3B, 3C and 3D illustrate various examples of interactions for the editing of a sentence or of a rule;

FIGS. 4A, 4B, and 4C illustrate diverse ergonomic or interface options.

### DETAILED DESCRIPTION OF THE INVENTION

The term “word” designates, in addition to the literal sense, a string of sounds or of graphical characters that form a semantic unit and that can be distinguished by a separator. A word is also a language element composed of one or more phonemes and which is susceptible of an individualized written transcription and participates in the syntactic and semantic functioning of an utterance.

A word, such as manipulated by the invention, can be a noun (common or proper), an adverb, an adjective, a verb, a pronoun, etc. Although the drawings illustrate the manipulation of the words of the natural language “and”, “or”, “not”, —which are also Boolean operators moreover—, the embodiments of the invention do not have to be confined to these words alone. An arbitrary word of the natural or ordinary language is manipulatable by the invention, for example and in particular a verb (such as “turn on” or “turn off”).

In addition to the literal sense of the term, “sentence” is intended to mean, notably, an element of expert knowledge. This includes but is not limited to a business rule (or management rule) which is a high-level structured statement. This type of rule makes it possible to constrain, control and influence an aspect of a “business”. In general, a rule is therefore a logical construction intended to describe operations, definitions, conditions and/or constraints which apply to certain predetermined data to achieve an objective.

In a general manner, a rule based system is a tool capable of reproducing the cognitive mechanisms of an expert, within a particular field. More precisely, an expert system is a piece of software capable of responding to questions, by performing reasoning on the basis of known facts and rules. It can serve notably as a decision aid tool. An expert system is composed of three parts: a fact base, a rule base and an inference engine. The inference engine is capable of using facts and rules to produce new facts, until it reaches the answer to the expert question posed. An expert system can rely on mechanisms of formal logic and use deductive reasoning. It can for example rely on propositional logic (“logic of order 0”), or else first-order predicate logic (“logic of order 1”). Fuzzy logic techniques can also be used.

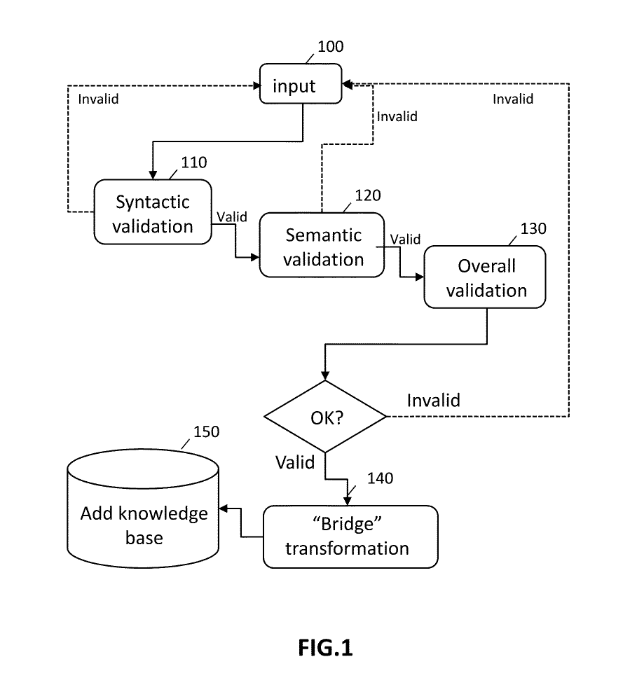

FIG. 1 presents a logical and general view of certain aspects of the invention. In a particular embodiment, there is defined a method (process) for manipulating a sentence expressed in natural language (for example for inputting a rule into a knowledge base), comprising several steps that can be conducted sequentially or in parallel (at least partially).

In an entry step 100, a first rule or sentence is entered (or “input” or “selected”) by the user. In particular, the initial rule can be any natural language sentence, such as provided by the user. The modes of entry include inputs by voice command or speech recognition, inputs on (physical or virtual) computer keyboards, and selection by pointer. The entry module may be for example a graphical interface (Graphical User Interface GUI or more generally Man-Machine Interface MMI), of a different nature (for example in the form of a text editor or dedicated interface, etc.), with which the user can interact to input knowledge. The sentence or rule is represented by a computer model.

In a syntactic validation step 110, the instance, arising from the previous step, of the computer model is verified so as notably to verify the consistency of the use of the various elements of which the sentence is composed. The syntactic validation can be performed by diverse means. A syntactic analyser (“parser”) can be used. The latter makes explicit the dependency relations (for example between subject and object) between the various lexemes, and then constructs a representation of dependencies (syntactic tree). The natural language processing may require particular processing (for example so-called tree adjoining grammars TAG, as opposed to non-contextual grammars which are generally used for formal languages). The analysis proper is generally nondeterministic (use of tabular procedures, CYK analysis, chart based, generalized LR analysis, etc.).

According to an “integrated” embodiment (particular and optional mode), the user is presented with the set of elements that can be used to maintain the syntactic validity of the sentence at a given time. Specifically, the user can select the element of his choice and move it to the knowledge (sentence) that he is in the process of inputting. In this embodiment, the possible destination locations are indicated to the user by anticipative feedback (i.e. feedforward), that is to say by means of a particular feedback loop, which presents the results obtained by anticipation of a possible action. The cognitive mode in and by which this feedback is obtained, i.e. the means used, depend on the type of computer peripheral used (PC, tablet, smartphone, etc). The system implemented can in particular include feedbacks of haptic (sensory), sound, visual, etc. type. For example, in an embodiment of the invention on a touch-sensitive tablet, the user may be led to perceive a visual feedback if a word is “dropped” at the wrong location (rebound effect, “refusal” of movement of the word, negative magnetization, etc.). The syntactic validation resides in the fact that the user can only choose an element that is compatible with the knowledge already input and that he can only place this element at a likewise compatible site.

In this embodiment, it is therefore noticeable that the entry module 100 and syntactic validation module 110 are integrated (“form just one”) and that the user is guided in his choices so that the knowledge he constructs can only be syntactically right or correct. Stated otherwise, the entry step 100 and validation step 110 are not decorrelated (i.e. they are related and can operate in combination). In the existing systems, the user must generally input his knowledge, and then validate it syntactically. If the syntactic validation fails, the user is constrained to correct his rule and to reattempt a syntactic validation until the latter is validated. This aspect of the invention (integration between input and syntactic validation), is therefore advantageous, notably in terms of swiftness of input and manipulation of the sentence, this having been validated experimentally.

In one embodiment, the vocabulary is defined and it is possible to drag elements of a rule as a function of the writing context so as to build the said rule. Through one or more indications (for example visual, sensory, auditory, etc. feedforward), the user is automatically diverted from possible syntactic or semantic errors and can read on the go the rule that he is in the process of drafting. The syntactic and semantic validation of the knowledge is transparent to the user. The latter can move elements of the graphical interface to one or more locations compatible with his choices and he receives appropriate feedback when he places an element at a potential site or when he tries to place it at a prohibited site. Thus, the correction is done in a progressive and iterative manner (“on the fly” and not as an a posteriori validation). The appearance of contextual alternatives makes it possible to limit the user's choice in terms of elements to be manipulated.

In a semantic validation step 120, the instance, validated in step 110, of the computer model is verified from the point of view of the consistency of the knowledge. In particular, the verification pertains to the consistency of the knowledge in relation to the representation of the world. The semantic analysis (“componential” analysis) of a sentence is the phase of its analysis which establishes the meaning thereof by using the sense of the words of the text, and is constructed on the basis of the syntactic analysis (“structural” analysis). The semantics gleaned generally takes three forms: “table”, “graph” (oriented graph for natural language), or “tree” (particular case of graph). In particular, one or more ontologies may be used. In knowledge management, an ontology represents an advanced form of semantic representation of knowledge.

The semantic verification or validation is a step which can be performed in various ways. During the semantic verification or validation, the consistency of the rule is verified, with respect to itself but also with respect to the other rules (for example present in the knowledge base, which may be static and/or predefined and/or closed (e.g. stable), or else dynamic (e.g. open); for example, the knowledge base may also result from searching over the network of already verified or validated rules). To verify the consistency of a given rule, it is possible, in an embodiment, to use algorithms which verify that its condition is not always true or always false. For example, contradictory logical relations (“A and B AND A and not B”) or duplicated logical relations (“A and B AND A and B”), inter alia, will lead to the rejection of the rule. To verify the consistency of a set of rules, in an embodiment, it is in particular possible to examine whether the inputs and the outputs of the system are all “covered” (that is to say for example to verify that the words input are known to the known or predefined vocabulary). It is also possible, in another embodiment, as a supplement or independently to study the inter-similarity of two rules (and/or of the inputs and/or outputs of the rules considered). Accordingly, it is possible to make a syntactic comparison (that is to say by comparing the words of the two rules, to within their order) or more thorough comparison according to the logic used. For example, in the case of a mode of implementation according to a fuzzy logic approach, it is possible to look at the coverage of the sets for defining the input linguistic variables, but also (and notably) the topology as well as the geometry of the membership functions used within these linguistic variables. It is also possible to verify the consistency of a group of rules on the basis of their representation in graph form, in which a search is conducted for possible cycles (“cycles” or “circuits”, i.e. if two rules do not contradict one another).

In an overall validation step 130, the sentence verified in step 120 is “validated”. The validation consists in verifying that this knowledge does not call into question knowledge already present in the knowledge base 150. In the case where all the previous steps have been cleared successfully, i.e. if the sentence is syntactically correct, semantically validated and compatible with the knowledge base 150, the new rule is imported into the said knowledge base via a module called a “bridge”, which module performs the transformation 140 of the sentence from one representation to the other. Stated otherwise, the “bridge” module (or “bridge step”) 140 is a module which makes it possible to transform the rule from one representation to the other. Indeed, in the module for inputting the rule 100, the sentence or rule is represented in a computerized manner by a certain model which may differ from the model in which the rule is stored in the knowledge base (for example, storage in the base may be performed by means of an XML file). Overall validation can therefore be done formally, i.e. in an automatic manner, with the aid of the “bridge” module.

Optionally, human expertise can be turned to good account downstream, for example with the aid of text mining or data mining techniques. The expert, during a knowledge discovery audit (or KDD, Knowledge Discovery in Databases), will respond to questions such as “is this known?”, “is this explicable?” or “is this useful?”. The semantics extracted and consolidated in the knowledge base 150 has the role of a “mapping” of the information, that is to say it makes it possible to say where the various items of information are situated with respect to one another.

Still optionally, fuzzy logic techniques can be implemented. Fuzzy logic can be used for the vocabulary and/or the grammar. Fuzzy logic can be applied (e.g. can govern) the selection and/or the choice and/or the validation and/or the filtering and/or the determination of the vocabulary. The vocabulary can be predefined. Independently or in combination, the grammar can be “a predefined grammar of fuzzy logic type”.

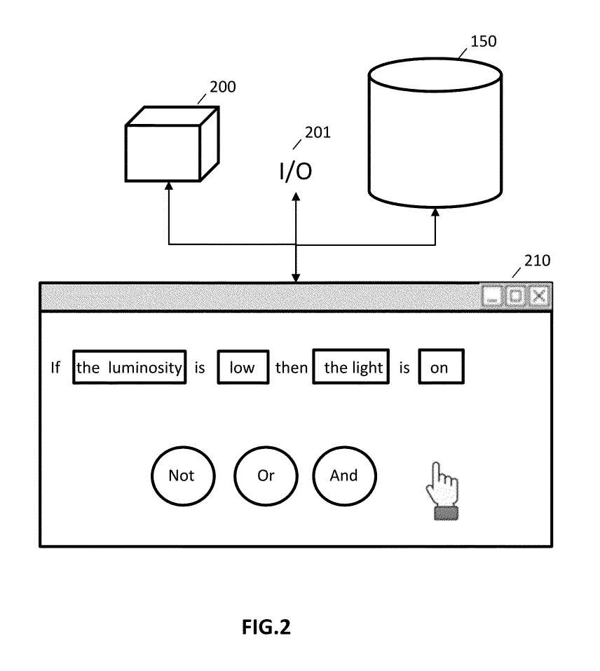

FIG. 2 illustrates an exemplary user interface. A user interface 210 is presented to the user. This interface is in conjunction with calculation means 200 and storage or memory means 150 (knowledge base for example). Diverse other I/O (input/output) means 201 can also be used (touch-sensitive interface, stylus, haptic feedback, physical or virtual keyboard, etc). The interface proper can resort to various display means (LCD screen, OLED, SED, holography, stereoscopy, 3D, projection, electronic ink, display of Braille type, etc) and/or to a combination of these means. FIG. 2 represents the inputting of a rule in a rule context for home automation: “if the luminosity is low then the light is turned on”. The user starts from this natural language sentence and wishes to modify this rule (interpreted and actuated in this precise case by a home-automation system). Fuzzy logic can make it possible to process a sentence or portion of sentence such as “if the luminosity is fairly low then . . . ”

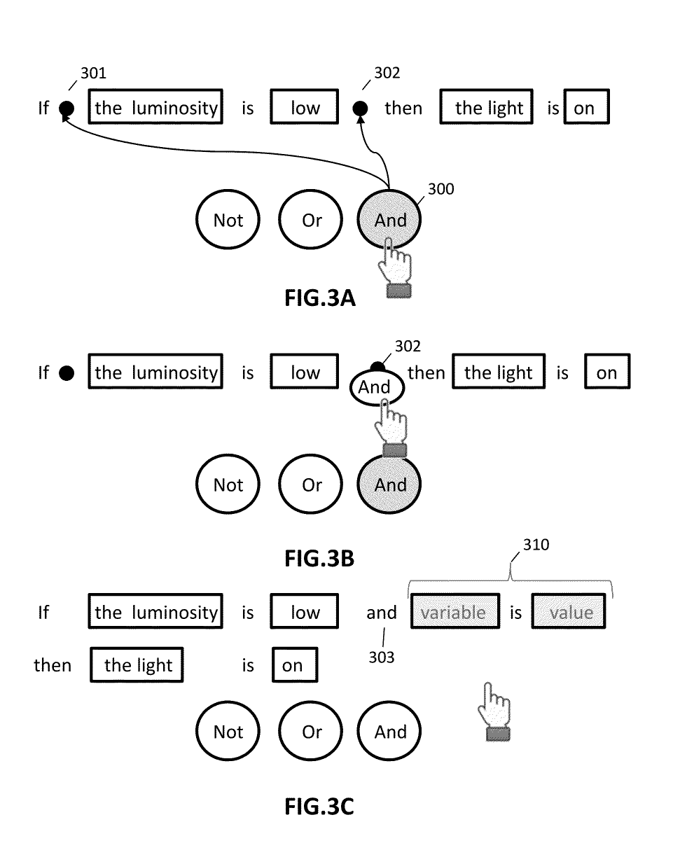

FIG. 3 illustrates various interactions for the editing of a sentence or rule. In the chosen example of the home-automation rule, the user wishes to enrich the rule by adding a logical Boolean operator “and” (mathematical “and”). In response to the selection by the operator of the corresponding icon or graphical element 300, the syntactic analysis of the sentence determines that only two sites are possible for such an insertion: the locations 301 and 302. Stated otherwise and for example, the syntactic analyser determines that the logical operator “and ” cannot lie in front of “low”: the sentence “if the luminosity is AND . . . low then the light is turned on” is syntactically incorrect. On the other hand, “if AND . . . the luminosity is low then the light is turned on” and “if the luminosity is low AND . . . then the light is turned on” are sentences that the syntactic analyser determines as possibly correct. The destination locations are then displayed and presented to the user in FIG. 3A. Typically, less than a few seconds (indeed less than a second of latency) elapse between the selection of the operator by the user and the display of the destination locations. As soon as the user has made his choice, by drag-and-drop in FIG. 3B, one or more “ghosts” appear, represented in FIG. 3C. On the form, these “ghosts” appear visually distinct from the remainder of the interface (greyed, floating, blinking or any other visual effect). On the background, the “ghosts” present the user with several possible choices, i.e. the choices that the procedure or the system considers or expects. In the home-automation example, selection followed by “drag-and-drop” of the logical operator “and” culminates in the request to create a second rule, by analogy with the first condition. The word “luminosity” being interpreted as a variable and “low” being interpreted as a value, the system displays the ghost 310 “AND . . . VARIABLE is VALUE, in the new conjunctive. The remainder of the sentence “then the light is turned on” is moved.

It is underlined that the examples of FIGS. 3A, 3B and 3C mention only examples (i.e. Boolean operators). The various procedures disclosed are not limited to these operators alone: verbs or adjectives (more generally any “word”) can also be manipulated, for example the action verb “turn on”.

In an optional manner, in an embodiment, a “ghost” can react to a stimulus of the user (for example a click) so as to propose the various possible forms to him, in such a way that the syntactic validation remains valid. For example, by designating (clicking, touching) the ghost “VARIABLE”, it will be possible for the user to bring up as proposals or suggestions the words “shutter” or “door” and the words “open” or “closed” for the ghost “VALUE”. In another embodiment, the user freely completes the various ghosts.

In other embodiments, various options are accessible, in a permanent or intermittent manner or contextually: copy, paste, cut, back, cancel the last operation, send to validation even if data incomplete, close, save as, quit etc.

In one embodiment, to validate the rule, the user must complete all the ghosts. Stated otherwise, a sentence or rule is not considered to be “syntactically right” if it still contains at least one “ghost”.

FIG. 3D illustrates the fact that a part of a sentence or of a rule (i.e. a group or grouping of words) can be selected and moved. In one embodiment, the syntax can be considered in a binary manner (i.e. “correct/incorrect”) or according to techniques pertaining to fuzzy logic.

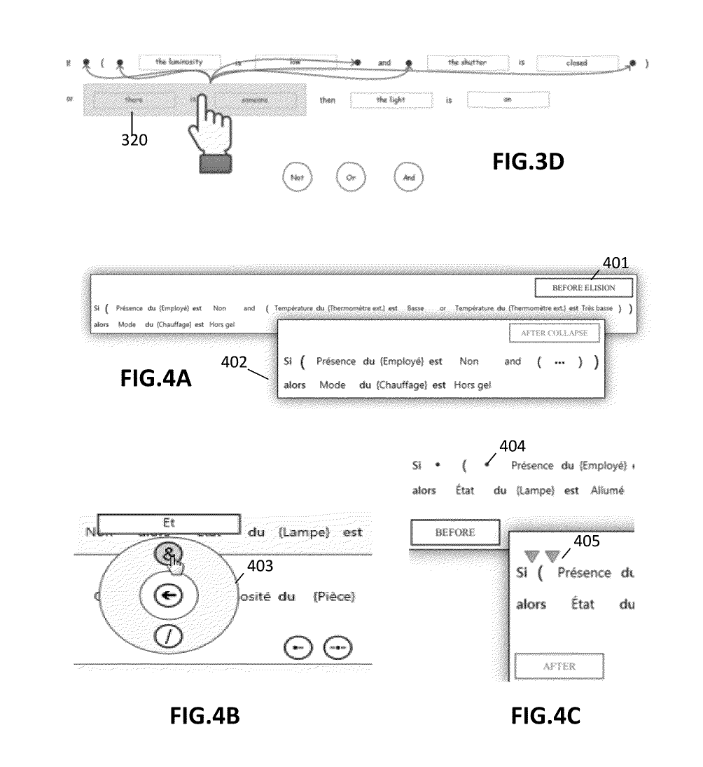

FIGS. 4A, 4B, and 4C illustrate diverse optimizations of the ergonomics or of the interface. These optional optimizations will, —in combination with the other aspects of natural language technical processing—, reinforce the cognitive gains from which the user benefits. FIG. 4A illustrates an advantageous development in regard to readability on the screen. When editing complex (therefore lengthy) rules, it may be advantageous to “reduce” (or “compact” or “concatenate”, “collapse”) parts of sentences. In the indicated example in FIG. 4, the rule 401 is condensed by eluding a conjunctive so as to display a reduced rule 402. FIG. 4B illustrates another ergonomic optimization. In order to display a plurality of logical operators, or generally a large number of possible choices to complete one or more “ghosts”, it appears advantageous to use a “radial” (or “pie”) view menu. This mode of representation consists of a circular and contextual menu, whose elements are represented dynamically, on request, around its centre. The triggering of a choice is effected in two stages: the display of the compact menu initially, and then the choice of the sub-element. In an optional manner, operators can be represented by graphical elements or icons. Such operators can be, for example, Boolean operators (“and”, “or”), or, more generally operators of “generic” or “proprietary” or “predefined” type (for example “after” or “front”, “as soon as”, etc). Access to categories is also possible via this type of interface, thereby allowing local and sometimes contextual navigation. FIG. 4C illustrates another optimization of the display by way of cursors 405 used instead of the indications of destination locations 404. The use of cursors consumes no, or almost no, display space, thereby allowing more compact displays improving the reading and writing speed in respect of the rules. This is particularly worthwhile when manipulating long sentences or rules (the layout of the sentences can remain unchanged, or at the least the impact in terms of visual rearrangements can be minimized).

As regards interface, a certain number of aspects are disclosed hereinafter. These aspects may (or may not) be inter-combined, according to various embodiments. These aspects are all optional. The available elements of a rule or of a sentence can be displayed in a part of the display device and can change as a function of the already assembled elements. Stated otherwise, the display can be contextual or contextualized, at least at certain times. The graphical elements displayed generally correspond to natural language (nouns, conjugated verbs, etc), or at least are representations which are very close to natural language, so as to facilitate their understanding by the uninitiated user, thus hiding the mathematical or logical complexity of the element. When a drag-and-drop is initiated by the user, the set of locations—on which the selected element can be dropped can be emphasized (so-called feedforward mode). When the selected element passes over a possible location, the user can receive a feedback (sound, luminous, touch-sensitive, sensory, etc). When an element is inserted, a “ghost” of the necessary elements directly involved can be added automatically.

The present invention can be implemented on the basis of hardware and/or software elements. It can be available in the guise of computer program product on a computer readable medium. The medium can be electronic, magnetic, optical, electromagnetic or be a diffusion medium of infrared type.

1. Method implemented by computer for manipulating a sentence expressed in natural language comprising the determination of one or more destination locations in an initial sentence in response to the selecting of one or more words, said destination locations being determined by a syntactic analyser.

2. Method according to claim 1, furthermore comprising the display of the destination location or locations in response to the selecting of the word or words.

3. Method according to claim 2, furthermore comprising the display of one or more suggestions of words corresponding to the one or more destination locations.

4. Method according to claim 1, furthermore comprising a semantic validation of the sentence formed by the insertion of the word or words selected in the initial sentence.

5. Method according to claim 4, the semantic validation being performed by logical verification.

6. Method according to claim 4 or 5, the semantic validation being performed by similarity comparison with rules known to be semantically valid.

7. Method according to claims 4 to 6 the semantic validation being performed by graph analysis.

8. Method according to claims 4 to 7, furthermore comprising the addition of the semantically valid sentence to the knowledge base.

9. Method according to claim 8, said addition comprising a transformation of the representation associated with the semantically valid sentence into a representation of rule compatible with the knowledge base.

10. Method according to any one of the preceding claims furthermore comprising the display of the sentence formed by the insertion of one or more words in response to the selecting of one or more destination location.

11. System for the implementation of the method according to any one of claims 1 to 10.

12. System according to claim 11, comprising an entry keyboard and/or a touch-sensitive interface.

13. System according to claim 11 or 12, furthermore comprising haptic feedback and/or sound emission and/or display means.

14. A computer program product, the said computer program comprising code instructions making it possible to perform the steps of the method according to any one of claims 1 to 10, when the said program is executed on a computer.
